(19) United States
(12) Patent Application Publication
(10) Pub. No.: US 2026/0144194 A1
(43) Pub. Date: May 28, 2026

(54) BLADE OF AN EDGER HAVING CLADDED SURFACES

(71) Applicant: Milwaukee Electric Tool Corporation, Brookfield, WI (US)

(72) Inventors: Choon Yen Kong, Braintree (GB); Pavel Sevcenko, Wickhambrook (GB); Ingars Kursitis, Wickhambrook (GB); Nathan M. Moore, Pewaukee, WI (US); Mark E. Kleeman, Milwaukee, WI (US); Karl J. Weber, Mequon, WI (US)

(21) Appl. No.: 19/359,358

(22) Filed: Oct. 15, 2025

Related U.S. Application Data
(60) Provisional application No. 63/725,198, filed on Nov. 26, 2024.
(60) Provisional application No. 63/727,937, filed on Dec. 4, 2024.
(60) Provisional application No. 63/746,383, filed on Jan. 17, 2025.

(51) Int. Cl. A01G 3/06; B26D 1/00

(52) U.S. Cl. CPC A01G 3/062; B26D 1/0006; B26D 2001/002

(57) ABSTRACT

Embodiments of a blade for a lawn edger tool are disclosed. The blade includes a blade body having a first major surface, a second major surface, and a minor surface. The second major surface is opposite to the first major surface, and the minor surface connects the first major surface and the second major surface around a perimeter of the blade body. A cladding layer is disposed on the minor surface at least partially around the perimeter of the blade body. The cladding layer includes particles of a carbide or abrasive material.

### CROSS-REFERENCE TO RELATED PATENT APPLICATIONS

The present application claims the benefit of and priority to U.S. Provisional Application No. 63/746,383, filed on Jan. 17, 2025, to U.S. Provisional Application No. 63/727,937, filed on Dec. 4, 2024, and to U.S. Provisional Application No. 63/725,198, filed on Nov. 26, 2024, which are each incorporated herein by reference in their entireties.

### BACKGROUND OF THE INVENTION

The present disclosure is directed generally to tool blades. The present disclosure relates specifically to a blade for an edger having a cladded edge.

### SUMMARY OF THE INVENTION

Various embodiments of the present disclosure relate to a blade for an edger having a cladding along one or more blade edges. In various embodiments, high wear areas of the edger blade include a cladding, specifically a cutting edge including carbide or abrasive particles.

In a first aspect, embodiments of the disclosure relate to a blade for a lawn edger tool. The blade comprises a blade body having a first major surface, a second major surface, and a minor surface. The second major surface is opposite to the first major surface, and the minor surface connects the first major surface and the second major surface around a perimeter of the blade body. A cladding layer disposed on the minor surface at least partially around the perimeter of the blade body. The cladding layer comprises at least one of an abrasive material or a carbide.

In a second aspect, embodiments of the disclosure relate to the blade according to the first aspect in which the minor surface comprises a first longitudinal edge, a second longitudinal edge, a first lateral edge, and a second lateral edge. The second longitudinal edge is opposite to the first longitudinal edge, and the second lateral edge is opposite to the first lateral edge. The first longitudinal edge and the second longitudinal edge each comprise a first length, and the first lateral edge and the second lateral edge each comprise a second length. The second length is less than the first length.

In a third aspect, embodiments of the disclosure relate to the blade according to the second aspect in which the cladding layer is disposed on each of the first lateral edge and the second lateral edge.

In a fourth aspect, embodiments of the disclosure relate to the blade according to the second aspect in which the cladding layer is disposed on each of the first longitudinal edge and the second longitudinal edge.

In a fifth aspect, embodiments of the disclosure relate to the blade according to the fourth aspect in which the cladding layer on each of the first longitudinal edge and the second longitudinal edge comprises a first clad section and a second clad section separated from the first clad section by a bare section.

In a sixth aspect, embodiments of the disclosure relate to the blade according to the fourth aspect or the fifth aspect in which the cladding layer is further disposed on the first lateral edge and the second lateral edge.

In a seventh aspect, embodiments of the disclosure relate to the blade according to any of the third aspect to the sixth aspect in which the cladding layer is further disposed in one or more strips on at least one of the first major surface or the second major surface.

In an eighth aspect, embodiments of the disclosure relate to the blade according to the sixth aspect in which the first longitudinal edge comprises a first curved region disposed proximal to the first lateral edge and the second longitudinal edge comprises a second curved region disposed proximal to the second lateral edge. The cladding layer is disposed in the first curved region and the second curved region.

In a ninth aspect, embodiments of the disclosure relate to the blade according to any of the first aspect to the eighth aspect in which the cladding layer comprises particles of at least one of a carbide, a nitride, a boride, an oxide, or diamond in a binder.

In a tenth aspect, embodiments of the disclosure relate to the blade according to any of the first aspect to the ninth aspect in which the cladding layer further comprises a barrier layer disposed between the minor surface and the carbide material.

In an eleventh aspect, embodiments of the disclosure relate to an edger blade. The edger blade comprises a blade body having a first major surface, a second major surface, and a minor surface. The second major surface is opposite to the first major surface, and the minor surface connects the first major surface and the second major surface around a perimeter of the blade body. The minor surface comprises a first longitudinal edge, a second longitudinal edge, a first lateral edge, and a second lateral edge. A cladding layer is disposed on at least one of the first major surface, the second major surface, the first longitudinal edge, the second longitudinal edge, the first lateral edge, or the second lateral edge. The cladding layer comprises a hardness in a range of 800 HV to 1500 HV.

In a twelfth aspect, embodiments of the disclosure relate to the edger blade of the eleventh aspect in which an average distance between the first major surface and the second major surface define a thickness of the blade body and in which the thickness is in a range of 1 mm to 5 mm.

In a thirteenth aspect, embodiments of the disclosure relate to an edger blade of the eleventh aspect or the twelfth aspect in which the first longitudinal edge and the second longitudinal edge each have a length in a range from 150 mm to 250 mm.

In a fourteenth aspect, embodiments of the disclosure relate to the edger blade of the thirteenth aspect in which the first lateral edge and the second lateral edge each having a length in a range from 35 mm to 65 mm.

In a fifteenth aspect, embodiments of the disclosure relate to the edger blade of any of the eleventh aspect to the fourteenth aspect in which the cladding layer is disposed on the first lateral edge and on the second lateral edge and in which the cladding layer extends along at least 50% of a length of each of the first lateral edge and the second lateral edge.

In a sixteenth aspect, embodiments of the disclosure relate to the edger blade of the fifteenth aspect in which the cladding layer is also disposed on each of the first longitudinal edge and the second longitudinal edge. On each of the first longitudinal edge and the second longitudinal edge, the cladding layer comprises a first clad section and a second clad section. The first clad section is separated from the second clad section by a bare section without the cladding layer, and each of the first clad section and the second clad section extends for at least 25% and less than 50% along a length of the respective first longitudinal edge and second longitudinal edge.

In a seventeenth aspect, embodiments of the disclosure relate to the edger blade of the sixteenth aspect in which the cladding layer further comprises at least one strip disposed on at least one of the first major surface or the second major surface.

In an eighteenth aspect, embodiments of the disclosure relate to the edger blade of the seventeenth aspect in which the blade body defines an aperture extending from the first major surface to the second major surface and in which the at least one strip comprises a first strip and a second strip disposed on opposite sides of the aperture.

In a nineteenth aspect, embodiments of the disclosure relate to the edger blade of the sixteenth aspect in which the first longitudinal edge comprises a first curved region disposed proximal to the first lateral edge and the second longitudinal edge comprises a second curved region disposed proximal to the second lateral edge. The cladding layer is disposed in the first curved region and the second curved region.

In a twentieth aspect, embodiments of the disclosure relate to the edger blade of any of the eleventh aspect to the nineteenth aspect in which the cladding layer comprises particles of at least one of a carbide, a nitride, a boride, an oxide, or diamond in a binder.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIGS. 1A-1C depict an edger power tool, including in use, having a cladded blade, according to an exemplary embodiment of the present disclosure;

FIGS. 2A-2E depict a blade having carbide cladding in various configurations, according to exemplary embodiments of the present disclosure;

FIG. 3 depicts a cross-sectional view of a blade with a cladded edge including a barrier layer and a carbide layer, according to an exemplary embodiment of the present disclosure;

FIG. 4 schematically depicts a deposition process for depositing the cladding layer on the edge of a strip of material for the blade body, according to an exemplary embodiment of the present disclosure;

FIG. 5 depicts a cross-sectional view of a blade with a cladded edge including only the carbide layer, according to an exemplary embodiment of the present disclosure; and

FIG. 6 depicts a flow diagram of a method for depositing the cladding layer on the edge of the blade body, according to an exemplary embodiment of the present disclosure.

### DETAILED DESCRIPTION

Referring generally to the figures, various embodiments of a blade for an edger power tool having a carbide edge are shown. In various embodiments, high wear areas of the edger blade include a carbide layer and specifically a carbide cutting edge. A carbide deposition process for forming a carbide layer on an edger blade is also shown.

### Exemplary Edger Power Tool

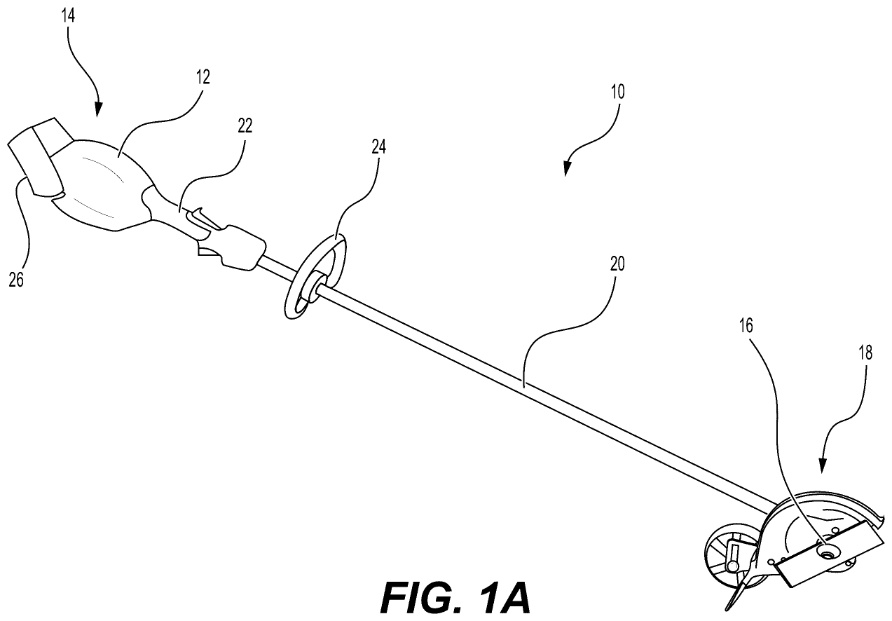

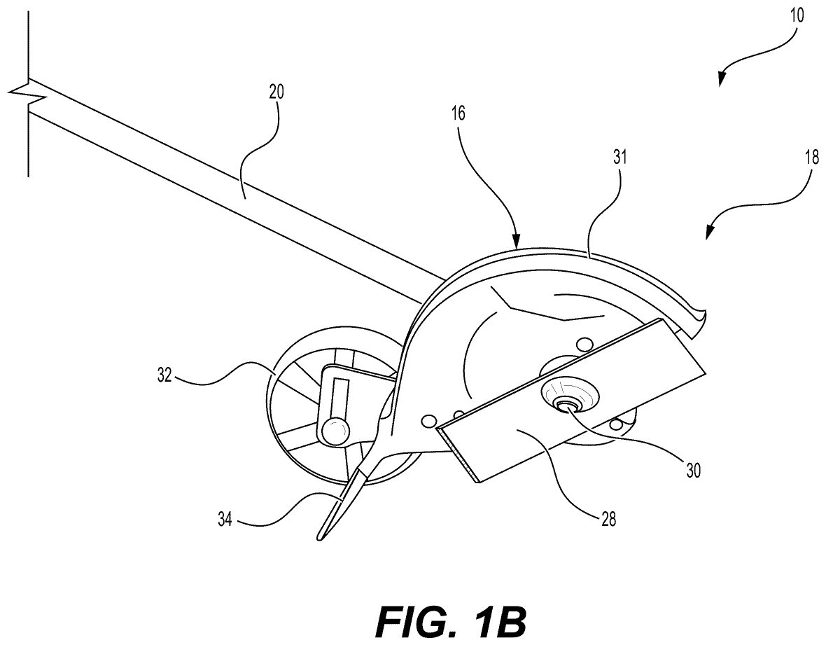

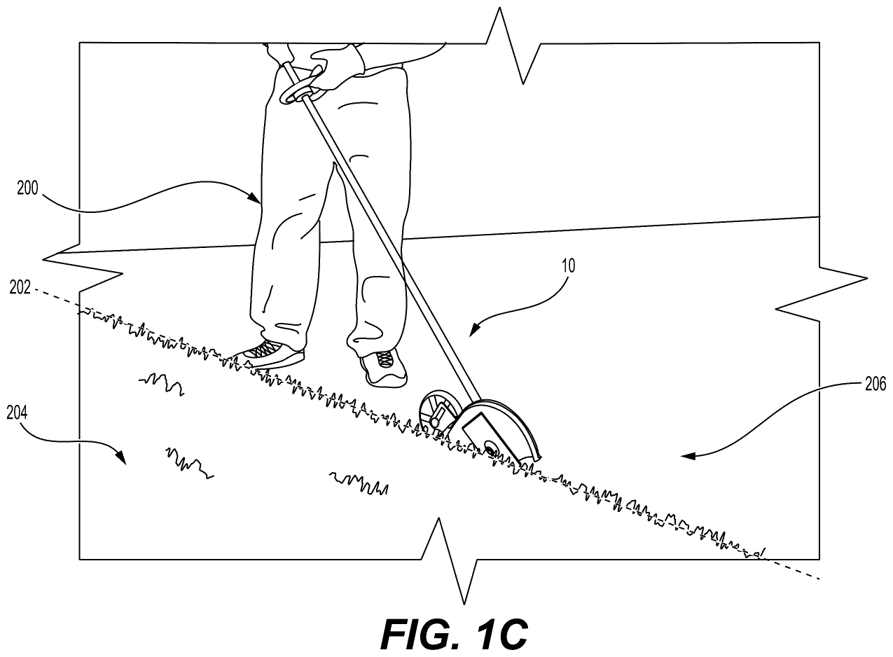

FIG. 1A depicts an exemplary embodiment of an edger power tool 10. The edger power tool 10 includes a drive mechanism 12 disposed at a first end 14 of the edger power tool 10, and an edging device 16 disposed at a second end 18 of the edger power tool 10. Disposed between the drive mechanism 12 and the edging device 16 is a pole 20. The drive mechanism 12 includes a first handle 22 which includes an actuator, such as one or more of a trigger or press button, for activating the drive mechanism 12 to power the edging device 16. A user holds the first handle 22 in a first hand to control operation of the drive mechanism 12. Further, in one or more embodiments, a second handle 24 is situated on the pole 20 proximal to the drive mechanism 12 by which the user directs and holds the edger power tool 10 with a second hand.

In one or more embodiments, the drive mechanism 12 is electrically powered. For example, as shown in FIG. 1A, the drive mechanism 12 may include a removable battery pack 26. In one or more other embodiments, the drive mechanism 12 may be electrically powered using a power cord plugged into a wall socket. In still one or more other embodiments, the drive mechanism may be powered using an internal combustion engine, running on gasoline, for example.

FIG. 1B depicts a detail view of the edging device 16. The edging device 16 operates using a rotating blade 28. The blade 28 is mounted on an arbor 30, which is driven by the drive mechanism 12. The drive mechanism 12 may drive the arbor 30 in a variety of different ways. For example, the drive mechanism 12 may rotate a driveshaft disposed within the pole 20, which is mechanically connected to the arbor 30 through gearing, such as a bevel gear arrangement. In this way, actuation of the drive mechanism 12 on the first end 14 of the edger power tool 10 causes rotation of the blade 28 of the edger device 16 at the second end 18 of the edger power tool 10.

In one or more embodiments, the blade 28 is at least partially shrouded with a cover 31 to provide protection against accidental contact with the blade 28. Further, in one or more embodiments, the cover 31 may include a wheel 32 that rolls over the ground, setting the depth of the blade 28 during edging. In still one or more other embodiments, the cover 31 includes a flap 34 configured to block grass, dirt, and other debris from being thrown back at the user during edging.

FIG. 1C depicts the edger power tool 10 in operation. In particular, a user 200 holds the edger power tool 10 and moves the edger power tool 10 along a boundary 202 between a section of grass 204 and a paved surface 206, for example. As shown in FIG. 1C, the wheel 32 rolls over the paved surface 206 with the blade 28 facing the grass 204 and the cover 31 facing the paved surface 206.

### Exemplary Cladding on Blade

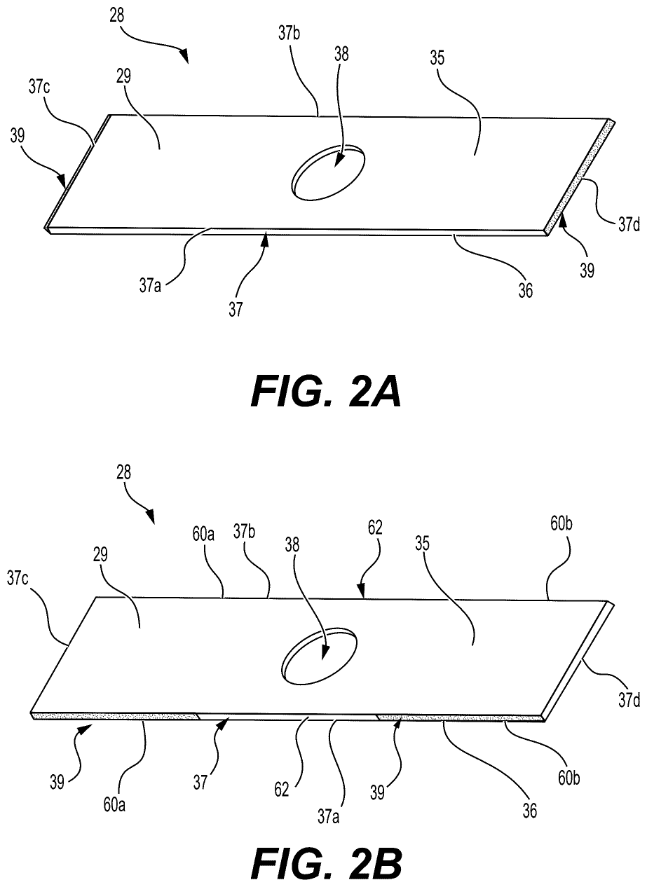

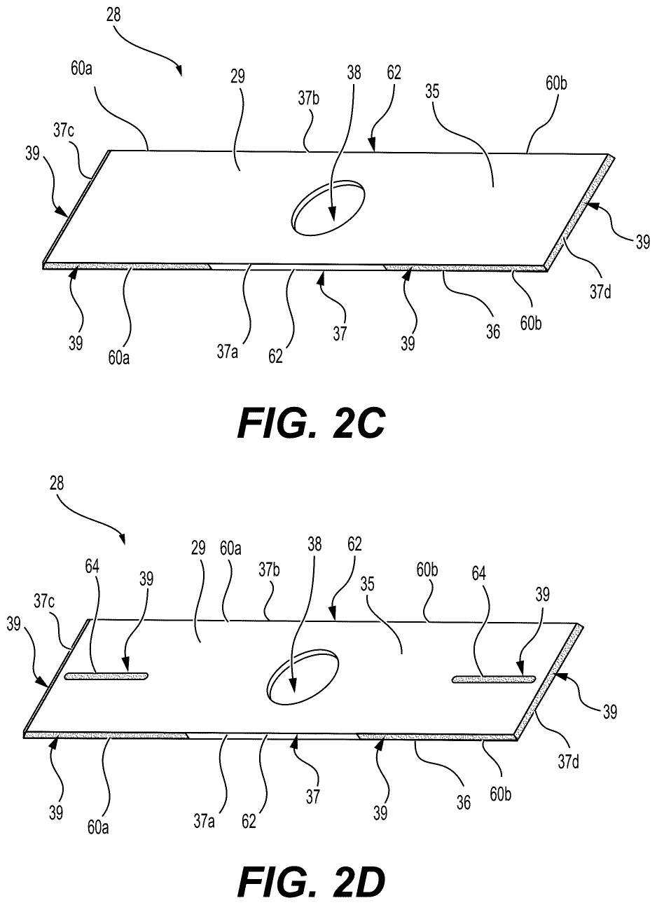

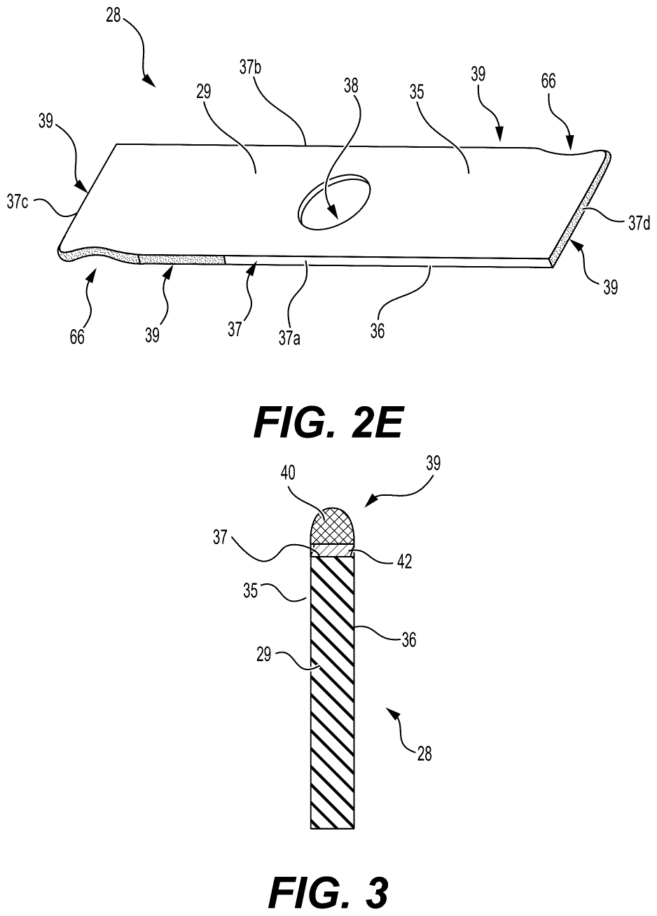

FIGS. 2A-2E depict example embodiments of the blade 28 configured for use with the edger power tool 10. As will be discussed more fully below, each of the embodiments of the blade 28 includes one or more edges at least partially clad with a carbide layer. Each blade 28 includes a body 29 comprising a first major surface 35 and a second major surface 36 opposite to the first major surface 35. A minor surface 37 of the blade body 29 connects the first major surface 35 to the second major surface 36 around the perimeter of the blade body 29. The first major surface 35, the second major surface 36, and the minor surface 37 together define boundaries of the body 29 of the blade 28.

In one or more embodiments, an average distance between the first major surface 35 and the second major surface 36 defines a thickness of the blade 28 in which the thickness is in a range from 1 mm to 5 mm, in particular in a range from 2 mm to 4 mm, and most particular in a range from 2 mm to 3 mm.

As can be seen in FIGS. 2A-2E, the blade 28 includes a central aperture 38 extending from the first major surface 35 through the body 29 to the second major surface 36. In one or more embodiments, the central aperture 38 has a diameter in a range of 20 mm to 30 mm, in particular about 25 mm. The arbor 30 (as shown in FIG. 1B) is inserted through the central aperture 38 to connect to blade 28 to the edging device 16.

The minor surface 37 includes a first longitudinal edge 37a, a second longitudinal edge 37b, a first lateral edge 37c, and a second lateral edge 37d. The first longitudinal edge 37a is opposite to the second longitudinal edge 37b, and the first lateral edge 37c is opposite to the second lateral edge 37d. The edges 37a-d define a generally rectangular perimeter of the blade 38 in which the first longitudinal edge 37a and the second longitudinal edge 37b are longer than the first lateral edge 37c and the second lateral edge 37d. In one or more embodiments, the first longitudinal edge 37a and the second longitudinal edge 37b each have a length in a range from 150 mm to 250 mm, in particular in a range from 175 mm to 225 mm, and most particularly in a range from 195 mm to 205 mm. In one or more embodiments, the first lateral edge 37c and the second lateral edge 37d each have a length in a range from 35 mm to 65 mm, in particular in a range from 45 mm to 55 mm, and most particularly in a range from 47 mm to 52 mm.

As will be discussed in relation to the embodiments shown in FIGS. 2A-2E, the blade 28 includes a cladding layer 39 on one or more of the first major surface 35, the second major surface 36, or the edges 37a-d.

Referring first to FIG. 2A, the blade 28 includes the cladding layer 39 on the first lateral edge 37c and the second lateral edge 37d. In one or more embodiments, the cladding layer 39 covers at least 50% of each lateral edge 37c, 37d, in particular at least 75% of each lateral edge 37c, 37d, and most particularly at least 90% of each lateral edge 37c, 37d. In one or more embodiments, the cladding layer 39 covers up to 100% of each lateral edge 37c, 37d. In one or more embodiments, the cladding layer 39 is continuous or discontinuous along the length of each lateral edge 37c, 37d.

Referring now to FIG. 2B, the blade 28 includes the cladding layer 39 on the first longitudinal edge 37a and the second longitudinal edge 37b. In one or more embodiments, the cladding layer 39 includes a first clad section 60a and a second clad section 60b having a bare (i.e., unclad) section 62 disposed between the first clad section 60a and the second clad section 60b. In one or more embodiments, the first clad section 60a extends along the first longitudinal edge 60a from the first lateral edge 37c to less than 50% of the length of the first longitudinal edge 60a, such as up to 40% of the length of the first longitudinal edge 60a. In one or more embodiments, the first clad section 60a extends along the first longitudinal edge 60a from the first lateral edge 37c to at least 25% of the length of the first longitudinal edge 60a. In one or more embodiments, the second clad section 60b extends along the first longitudinal edge 60a from the second lateral edge 37d to less than 50% of the length of the first longitudinal edge 60a, such as up to 40% of the length of the first longitudinal edge 60a. In one or more embodiments, the second clad section 60b extends along the first longitudinal edge 60a from the second lateral edge 37d to at least 25% of the length of the first longitudinal edge 60a. The second longitudinal edge 37b may include a first clad section 60a, a second clad section 60b, and a bare section 62 as described in relation to the first longitudinal edge 37a.

With reference now to FIG. 2C, the blade 28 includes the cladding layer 39 on the first longitudinal edge 37a, the second longitudinal edge 37b, the first lateral edge 37c, and the second lateral edge 37d. In one or more embodiments, the cladding layer 39 on the first lateral edge 37c and the second lateral edge 37d is as described in relation to FIG. 2A, and the cladding 39 on the first longitudinal edge 37a and the second longitudinal edge 37b is as described in relation to FIG. 2B. Thus, the embodiment shown in FIG. 2C can be considered a combination of the embodiments shown and described in relation to FIGS. 2A and 2B.

FIG. 2D depicts still another embodiment of the blade 28 in which the cladding layer 39 is provided on the first longitudinal edge 37a, the second longitudinal edge 37b, the first lateral edge 37c, and the second lateral edge 37d as shown in FIG. 3C, and in the embodiment of FIG. 2D, the blade 28 further includes one or more strips 64 strips of cladding layer 39 on the first major surface 35 and/or the second major surface 36. In one or more embodiments, the strips 64 have a length that is from 10% to 40% of the length of the first longitudinal edge 37a. As shown in FIG. 2D, the blade 28 includes one strip 64 on each side of the central aperture 38, positioned proximal to respective lateral edge 37c, 37d; however, in one or more other embodiments, the blade 28 may include a plurality of strips 64 disposed on each side of the central aperture 38, spatially disposed from one another between the first longitudinal edge 37a and the second longitudinal edge 37b.

In still one or more other embodiments, including the embodiment shown in FIG. 2E, the first longitudinal edge 37a and the second longitudinal edge 37b each include a curved region 66. In one or more embodiments, the curved region 66 of the first longitudinal edge 37a is disposed proximal to the first lateral edge 37c, and the curved region 66 of the second longitudinal edge 37b is disposed proximal to the second lateral edge 37d.

In one or more embodiments, the curved region 66 has a maximum depth from the longitudinal edge 37a, 37b in a range of 5 mm to 30 mm, in particular in a range of 10 mm to 20 mm.

In one or more embodiments, the blade 28 includes the cladding layer 39 over the curved region 66 of each of the first longitudinal edge 37a and the second longitudinal edge 37b. Further, in one or more embodiments, the cladding layer 39 is also disposed on the first lateral edge 37c and the second lateral edge 37d.

### Exemplary Cladding Deposition Process

In various embodiments, the blade 28 shown in herein is formed as shown in FIGS. 3-6. As can be seen in FIG. 3, the cladding layer 39 includes a hard phase layer 40 and optionally a barrier layer 42 deposited on the blade body 29. The blade body 29 makes up the most substantial part of the blade 28. In one or more embodiments, the hard phase layer 40 is deposited directly onto the blade body 29, e.g., on one or more of the edges 37a-d, the first major surface 35 and/or second major surface 36. However, in one or more other embodiments, the barrier layer 42 may optionally be disposed between the blade body 29 and the hard phase layer 40, continuously separating the blade body 29 from the hard phase layer 40. In one or more such embodiments, the barrier layer 42 may be used to prevent diffusion of elements from the blade body 29 into the hard phase layer 40, which may make the hard phase layer 40 too brittle.

In one or more embodiments, the blade body 29 is formed of a steel alloy, such as 65Mn steel.

In one or more embodiments, the hard phase layer 40 includes one or more carbide materials or abrasive particles in a binder material. In one or more embodiments, the carbide materials include at least one of tungsten carbide (WC), chromium carbide (e.g., Cr₃C₂), titanium carbide (TiC), tantalum carbide (TaC), or niobium carbide (NbC), among other possibilities. In one or more embodiments, the abrasive particles include at least one of nitrides (e.g., cubic boron nitride and silicon nitride), borides (e.g., silicon boride), oxides (e.g., alumina), or diamond. In one or more embodiments, the binder material includes at least one of nickel, cobalt, chromium, iron, or molybdenum, among other possibilities. In one or more embodiments, the hard phase layer 40 includes the carbide or abrasive material in an amount in a range from 25 wt % to 95 wt %, in particular from 30 wt % to 90 wt %. In one or more embodiments, the hard phase layer 40 includes binder material in an amount in a range from 5 wt % to 75 wt %, in particular from 10 wt % to 70 wt %. In one or more particular embodiments, the hard phase layer 40 is formed from a powder blend comprising tungsten carbide (WC) in a cobalt (Co) and chromium (Cr).

In one or more embodiments in which the barrier layer 42 is provided, the barrier layer 42 comprises a metal or alloy dissimilar from the material of the blade body 29 to prevent diffusion of the material of the blade body 29 into the hard phase layer 40. In particular, the barrier layer 42 does not include the primary elemental constituent of the metal or alloy of the blade body 29. For example, if the blade body 29 is made from a steel alloy, then the barrier layer 42 does not include iron. In one or more embodiments, the barrier layer 42 comprises a cobalt-chromium alloy, in particular comprising about 28 wt % to about 29 wt % chromium, about 5 wt % to about 6 wt % molybdenum, and the balance cobalt.

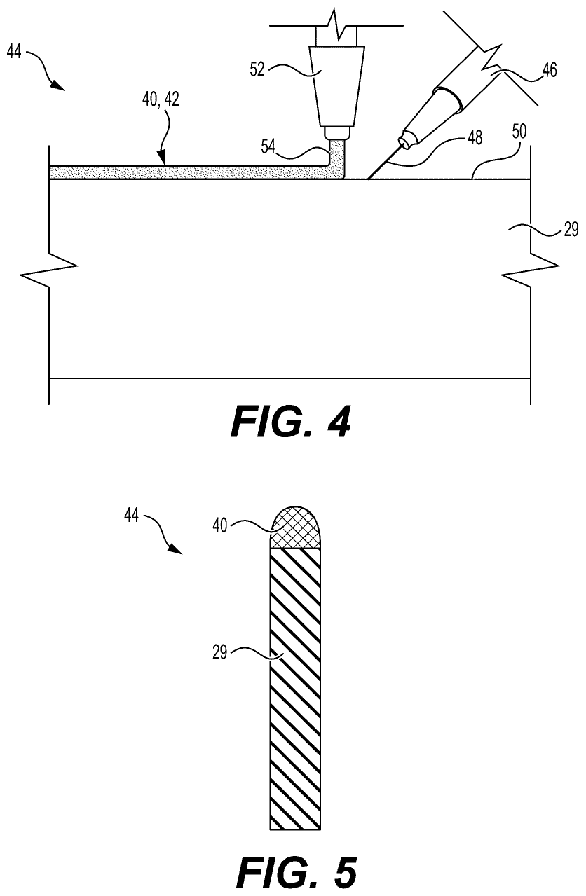

FIG. 4 depicts an embodiment of a setup for depositing the hard phase layer 40 (and barrier layer 42, if provided) on a strip 44 of material for the blade body 29. As shown in FIG. 4, a laser 46 emits a beam 48 on an edge surface 50 of the strip 44, which melts the strip 44 in the region of the edge surface 50. A nozzle 52 directs powder 54 of the material of the hard phase layer 40 (or barrier layer 42, if provided) onto the molten edge surface 50 of the strip 44, causing the powder 54 to melt and fuse to the blade strip 44. During deposition, the strip 44 and the laser 46 and nozzle 52 move relative to each other. In one or more embodiments, the laser 46 and the nozzle 52 are stationary, and the strip 44 moves past the laser 46 and nozzle 52. In one or more other embodiments, the laser 46 and the nozzle 52 move across a stationary strip 44.

In one or more embodiments, the powder 54 comprises particles of the abrasive or metals that make up the hard phase layer 40. In one or more embodiments, the powder 54 of the hard phase layer 40 includes metal alloy powder and carbon powder. In such embodiments, carbides (such as tungsten carbide and/or chromium carbide) precipitate in the melt pool and solidify in the metal matrix during cooling. The metal alloy particles may be generally spherical and have a size of up to 120 microns, in particular in a range from 11 microns to 53 microns. The carbon powder may have a flaky morphology with an average particle size of up to 120 microns, in particular in a range of 7 microns to 11 microns.

In one or more other embodiments, the powder 54 includes carbide particles and binder particles. In one or more embodiments, the carbide particles comprise tungsten carbide and the binder particles comprise cobalt and/or chromium, for example. In one or more embodiments, the powder 54 includes abrasive particles and binder particles.

In one or more embodiments, a wire comprising the material of the hard phase layer 40 and/or the barrier layer 42, instead of a powder, is fed into the melt pool formed by the laser 46.

In one or more embodiments, the hard phase layer 40 is deposited in multiple layers. Each layer has a thickness in a range from 0.1 mm to 0.2 mm, in particular about 0.15 mm. In one or more such embodiments, the hard phase layer 40 may include, for example, from two to five layers. In one or more embodiments, the hard phase layer 40 has a total thickness in a range from about 0.4 mm to 1 mm, in particular in a range from about 0.6 to about 0.8 mm.

FIG. 5 depicts a cross-sectional view of a strip 44 having the hard phase layer 40 deposited directly thereon. As can be seen, the deposited hard phase layer 40 forms a parabolic surface on the edge surface 50 of the strip 44. In one or more embodiments, the parabolic surface may be substantially smooth, but in one or more other embodiments, the parabolic surface may have a rough texture, like a weld seam.

If the optional barrier layer 42 is provided, the barrier layer 42 is deposited on the strip 44, and afterwards, the hard phase layer 40 is deposited on the barrier layer 42. The barrier layer 42 is deposited using substantially the same setup and procedure as shown and described in relation to FIG. 4. In particular, the laser 46 is directed over the edge surface 50 of the strip 44 to melt the edge surface 50 while the powder 54 of the barrier layer 42 is directed into the melted edge surface 50. After deposition of the barrier layer 42, the laser 46 is directed over the barrier layer 42 to melt at least a portion of the barrier layer 42, and powder 54 of the hard phase layer 40 is directed onto the molten barrier layer 42 by the nozzle 52. While reference is made to FIG. 4, the laser and nozzle used to apply the barrier layer 42 is not necessarily the same laser and nozzle used to apply the hard phase layer 40.

In one or more embodiments, the powder 54 of the barrier layer 42 comprises particles having an average size in a range from 15 microns to 45 microns. In one or more embodiments, the particles of the powder 54 have a generally spherical shape. In one or more embodiments, the barrier layer 42 is deposited having a thickness of about 0.1 mm. The final barrier layer 42 may be made up of one or multiple layers of the material of barrier layer 42 deposited by one or multiple passes by the laser 46 and nozzle 52 over the strip 44.

As the barrier layer 42 (if provided) and hard phase layer 40 may each be built up in one or more layers, multiple laser/nozzle stations may be used to apply each individual layer in sequential fashion. For example, a moving strip 44 of blade body 29 may pass by several laser/nozzle stations where the layers of barrier material and carbide material are applied.

Where provided, the barrier layer 42 provides a continuous separation between the hard phase layer 40 and the blade body 29. In particular, the barrier layer 42 separates the hard phase layer 40 from the blade body 29 across the thickness of the strip 44 and along the length of the strip 44. As discussed above, the separation provided by the barrier layer 42 prevents diffusion of elements from the blade body 29 into the hard phase layer 40, which can cause formation of brittle phases in the hard phase layer 40, especially for carbide materials, that may lead to premature failure of the blade 28.

After deposition of the hard phase layer 40 (and optionally the barrier layer 42), the strip 44 may optionally be heat treated in a furnace to refine the hard phase and removes porosity and cracks in the hard phase layer 40. In one or more embodiments, heat treating involves heating the strip at a rate in a range of 80°C/min to 140°C/min (in particular at about 120°C/min) to a temperature in a range of 1050° C. to 1200° C. (in particular to about 1115° C.), holding at that temperature for a time in a range from 1 minute to about 10 minutes (in particular about 3 minutes), and then air quenching to room temperature. In one embodiment, the hard phase layer 40 after deposition provides a blunt, rounded edge as shown in FIGS. 3 and 5. In one or more embodiments, after heat treating (if performed), the strip 44 may optionally be ground to provide a desired edge profile of the blade 28. Further, the strip 44 may be divided into individual blades 16, such as by cutting or stamping the strip 44.

Additionally, as shown in FIGS. 2A-2E, the cladding layer 29 may be on both longitudinal edges 37a, 37b and on lateral edges 37c, 37d, and after depositing the cladding layer 29 on either of the longitudinal edges 37a, 37b or the lateral edges 37c, 37d in strip 44 form, it may be necessary to deposit the cladding layer 39 on the other of the longitudinal edges 37a, 37b or the lateral edges 37c, 37d after cutting or stamping the strip 44 into individual blades 28. In one or more embodiments, the cladding layer 39 may be deposited on the first major surface 35 and/or the second major surface 36 while in the strip 44 or after cutting/stamping into individual blades 28.

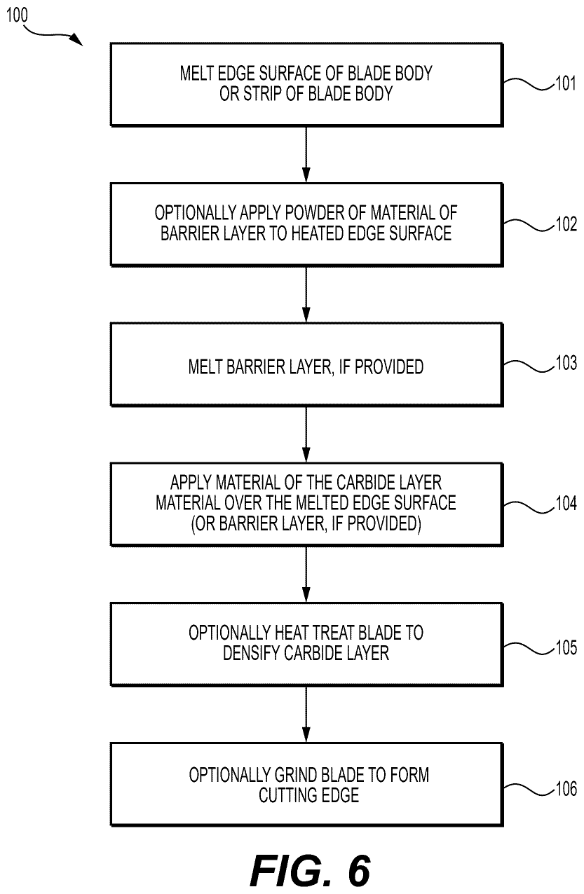

FIG. 6 provides a flow diagram of a method 100 for producing a blade 28 according to the present disclosure. In particular, the method 100 describes the embodiment in which the optional barrier layer 42 is provided. In a first step 101 of the method, the edge surface 50 of a blade body 29 or a strip of blade body 29 is heated, in particular melted (i.e., heated to a molten state). As depicted in FIG. 4, heating may be accomplished using a laser, but other means of heating the edge surface 50 are also possible, such electron beam, induction heating, and plasma arc, among others. After the edge surface 50 is melted, a powder or wire of the material of the barrier layer 42 is applied to the edge surface 50 in a second step 102 to form the barrier layer 42. As shown in FIG. 4, the heating (step 101) and applying (step 102) may be performed substantially simultaneously. In a third step 103, the barrier layer 42 is heated, in particular melted, and in a fourth step 104, the hard phase layer 40 is applied over the barrier layer 42. As discussed above, the hard phase layer 40 may be applied as a powder or a wire. For example, a powder of metal particles and carbon flakes may be applied such that carbides precipitate in the melt pool, or powders of the carbide or abrasive particles and binder material may be applied. In still another example, a wire of the hard phase material may be fed into the melt pool, or multiple wires (e.g., one containing the hard phase particles and one containing the binder) may be fed into the melt pool. Further, as discussed above, the material of the barrier layer 42 and the material of the hard phase layer 40 may be applied in multiple layers by multiple passes of the heating device and nozzle. Still further, the barrier layer 42 and the hard phase layer 40 may be applied on the blade 28 or strip 44 by passing the blade 28 or strip 44 under multiple stations of the heating device and nozzle, each station configured to provide the desired mix of powders/wires to form the barrier layer 42 and the hard phase layer 40. In an optional fifth step 105, the blade 28 or strip 44 is heat treated, and in an optional sixth step 106, the blade 28 or strip 44 is ground to form a desired edge profile.

If the barrier layer 42 is not provided, then the method 100 may comprise the steps of melting the edge surface of the blade body (step 101) followed by or simultaneously with applying the material of the hard phase layer over the melted edge surface (step 104). Thus, the method 100 may consist of these two steps, i.e., without deposition of the barrier layer (steps 102 and 103) and without further edge processing (heat treating step 105 and grinding step 106).

In the blade 28 according to the present disclosure and produced according to the disclosed process, the barrier layer 42 (if provided) will generally have the lowest hardness, and the hard phase layer 40 will have the highest hardness. The material of the blade body 29 will generally have a hardness between that of the barrier layer 42 and the hard phase layer 40. Further, the material of the blade body 29, especially when the material is a steel alloy, may have a gradient of hardness as a result of hardening caused by the heat-affected zone in the blade body 29 during heating of the edge surface 50 and barrier layer 42 while applying the barrier layer 42 and the carbide layer 40.

In embodiments where provided, the barrier layer 42 will remelt during application of the hard phase layer 40, but the material of the barrier layer 42 may be selected such that it does not harden during such remelting and cooling. Instead, the barrier layer 42 may soften because the remelting may homogenize the barrier layer 42. Notwithstanding, some minor diffusion between the blade body 29 and the barrier layer 42 and between the barrier layer 42 and the hard phase layer 40 may take place that may increase the hardness of the barrier layer 42 at the interfaces with the blade body 29 and hard phase layer 40, respectively.

After heat-treatment, in one or more embodiments, the blade body 29 has a hardness in a range of 600 HV to 700 HV in a region adjacent to the barrier layer 42, the barrier layer 42 has hardness in a range from 400 HV to 550 HV, and the hard phase layer 40 has a hardness in a range from 800 HV to 1500 HV.

Additional details are shown and described in the accompanying figures.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A blade for an edger power tool, the blade comprising:
a blade body having a first major surface, a second major surface, and a minor surface, the second major surface being opposite to the first major surface, and the minor surface connecting the first major surface and the second major surface around a perimeter of the blade body; and
a cladding layer disposed on the minor surface at least partially around the perimeter of the blade body;
wherein the cladding layer comprises at least one of abrasive particles or carbides.

2. The blade according to claim 1, wherein the minor surface comprises a first longitudinal edge, a second longitudinal edge, a first lateral edge, and a second lateral edge;
wherein the second longitudinal edge is opposite to the first longitudinal edge;
wherein the second lateral edge is opposite to the first lateral edge;
wherein the first longitudinal edge and the second longitudinal edge each comprise a first length; and
wherein the first lateral edge and the second lateral edge each comprise a second length, the second length being less than the first length.

3. The blade according to claim 2, wherein the cladding layer is disposed on each of the first lateral edge and the second lateral edge.

4. The blade according to claim 2, wherein the cladding layer is disposed on each of the first longitudinal edge and the second longitudinal edge.

5. The blade according to claim 4, wherein the cladding layer on each of the first longitudinal edge and the second longitudinal edge comprises a first clad section and a second clad section, the first clad section being separated from the second clad section by a bare section without the cladding layer.

6. The blade according to claim 4, wherein the cladding layer is further disposed on the first lateral edge and the second lateral edge.

7. The blade according to claim 6, wherein the cladding layer is further disposed in one or more strips on at least one of the first major surface or the second major surface.

8. The blade according to claim 6, wherein the first longitudinal edge comprises a first curved region disposed proximal to the first lateral edge and the second longitudinal edge comprises a second curved region disposed proximal to the second lateral edge; and
wherein the cladding layer is disposed in the first curved region and the second curved region.

9. The blade according to claim 1, wherein the cladding layer comprises particles of at least one of a carbide, a nitride, a boride, an oxide, or diamond in a binder.

10. The blade according to claim 1, wherein the cladding layer further comprises a barrier layer disposed between the minor surface and the carbide material.

11. An edger blade, the edger blade comprising:
a blade body having a first major surface, a second major surface, and a minor surface, the second major surface being opposite to the first major surface, the minor surface connecting the first major surface and the second major surface around a perimeter of the blade body, and the minor surface comprising a first longitudinal edge, a second longitudinal edge, a first lateral edge, and a second lateral edge; and
a cladding layer disposed on at least one of the first major surface, the second major surface, the first longitudinal edge, the second longitudinal edge, the first lateral edge, and the second lateral edge;
wherein the cladding layer comprises a hardness in a range of 800 HV to 1500 HV.

12. The edger blade of claim 11, wherein an average distance between the first major surface and the second major surface define a thickness of the blade body, the thickness being in a range of 1 mm to 5 mm.

13. The edger blade of claim 12, wherein the first longitudinal edge and the second longitudinal edge each have a length in a range from 150 mm to 250 mm.

14. The edger blade of claim 13, wherein the first lateral edge and the second lateral edge each having a length in a range from 35 mm to 65 mm.

15. The edger blade of claim 11, wherein the cladding layer is disposed on the first lateral edge and on the second lateral edge and wherein the cladding layer extends along at least 50% of a length of each of the first lateral edge and the second lateral edge.

16. The edger blade of claim 15, wherein the cladding layer is also disposed on each of the first longitudinal edge and the second longitudinal edge;
wherein, on each of the first longitudinal edge and the second longitudinal edge, the cladding layer comprises a first clad section and a second clad section;
wherein the first clad section is separated from the second clad section by a bare section without the cladding layer; and
wherein each of the first clad section and the second clad section extends for at least 25% and less than 50% along a length of the respective first longitudinal edge and second longitudinal edge.

17. The edger blade of claim 16, wherein the cladding layer further comprises at least one strip disposed on at least one of the first major surface or the second major surface.

18. The edger blade of claim 17, wherein the blade body defines an aperture extending from the first major surface to the second major surface and wherein the at least one strip comprises a first strip and a second strip disposed on opposite sides of the aperture.

19. The edger blade of claim 16, wherein the first longitudinal edge comprises a first curved region disposed proximal to the first lateral edge and the second longitudinal edge comprises a second curved region disposed proximal to the second lateral edge; and
wherein the cladding layer is disposed in the first curved region and the second curved region.

20. The edger blade of claim 11, wherein the carbide material comprises particles of at least one of a carbide, a nitride, a boride, an oxide, or diamond in a binder.
